(19) United States
(12) Patent Application Publication
(10) Pub. No.: US 2018/0050415 A1
(43) Pub. Date: Feb. 22, 2018

(54) TORCH QUICK RELEASE MECHANISM

(71) Applicant: LINCOLN GLOBAL, INC., Santa Fe Springs, CA (US)

(72) Inventor: JEFFREY L. KACHLINE, HIGHLAND HEIGHTS, OH (US)

(21) Appl. No.: 15/607,823

(22) Filed: May 30, 2017

Related U.S. Application Data
(60) Provisional application No. 62/375,737, filed on Aug. 16, 2016.

(51) Int. Cl. B23K 9/12; B23K 9/133; B23K 9/32

(52) U.S. Cl. CPC B23K 9/125; B23K 9/323; B23K 9/1336

(57) ABSTRACT

The invention described herein generally pertains to a system and method related to an automatic, semi-automatic or a manual welding operation and utilizing a quick release mechanism to removeably secure a torch to a wire feeder or a torch cable to a wire feeder. The quick release mechanism can be configured to attach through a sidewall of a female member coupled to a wire feeder, wherein the quick release mechanism engages a male member inside the female member to couple or decouple the torch from the wire feeder.

### CROSS-REFERENCE TO RELATED APPLICATIONS

This application is a continuation of and claims the benefit of U.S. Provisional Application Ser. No. 62/375,737 filed on Aug. 16, 2016. The entirety of such application is incorporated herein by reference.

### TECHNICAL FIELD

In general, the present invention relates to a quick release mechanism used with a welding device that performs a welding operation, wherein the quick release mechanism facilitates connecting and disconnecting a torch to a wire feeder.

### BACKGROUND OF THE INVENTION

Welding devices or systems often include a screw system that is used to secure a torch to a wire feeder. The torch assembly for connectivity to a wire feeder includes the torch with a male insert that mates with a female part, wherein the female part contains a separate piece that gets wedged into contact with the male member as the screw system is tightened. If the screw system that secures or tightens the separate piece becomes loose over time or is not secured tight enough, the torch can separate from the feeder. When the screw system is loose, the torch can push out of the feeder and wire can escape from the intended conduit path causing a short. This short can often cause damage to the surrounding area. Accordingly, an improved welding device, methodology, and/or system addressing these concerns is needed.

### SUMMARY OF THE INVENTION

In accordance with an embodiment of the present invention, a connection system used with a welding system having a torch and a wire feeder, that can include the following: a quick release mechanism that includes a body that is configured to be inserted through an aperture on a sidewall of a female member in which the female member is coupled to a wire feeder; a torch cable having a first end and a second end opposite thereto, the first end utilizes a first connection assembly to couple to a wire exit location of the wire feeder and the second end attaches to a torch, wherein the wire feeder delivers wire from the exit wire location through the torch cable to the torch for performance of a welding operation; the first connection assembly includes a male member integrated to the first end of the torch cable, wherein the male member mates with the female member to couple the torch cable to the wire exit location of the wire feeder; the male member includes a groove around a circumference of a sidewall of the first end of the male member; the body housing a pin that engages with the groove; and the quick release mechanism includes a handle that controls the pin and engagement with the groove, wherein the engagement of the pin within the groove attaches the male member to the female member and disengagement of the pin from the groove allows detachment of the male member from the female member.

In accordance with an embodiment of the present invention, a welder system is provided that includes at least the following: a power supply configured to output a welding current to an electrode to create an arc between the electrode and a workpiece; a wire feeder configured to deliver a welding wire to the arc; at least one welding torch for performing a welding operation on the workpiece to create a weld joint, the welding torch includes the electrode; a torch cable having a first end and a second end opposite thereto, the first end utilizes a first connection assembly to couple to a wire exit location of the wire feeder and the second end attaches to the at least one welding torch, wherein the wire feeder delivers wire from the exit wire location through the torch cable to the at least one welding torch for performance of the welding operation; the first connection assembly includes a male member integrated to the first end of the torch cable, wherein the male member mates with the female member to couple the torch cable to the wire exit location of the wire feeder; the male member includes a groove around a circumference of a sidewall of the first end of the male member; a quick release mechanism attached to the wire feeder, the quick release mechanism. The quick release mechanism can include a body that is configured to be inserted through an aperture on a sidewall of a female member; the body housing a pin that engages with the groove; and a handle that controls the pin and engagement with the groove, wherein the engagement of the pin within the groove attaches the male member to the female member and disengagement of the pin from the groove allows detachment of the male member from the female member.

In accordance with an embodiment of the present invention, a wire delivery system is provided that includes at least the following: a wire source that provide a wire to a wire feeder at a wire entrance location; one or more drive rolls that drive the wire from the wire entrance location to a wire exit location and through a torch cable to a torch; a quick release mechanism that releaseably secures the torch cable to the wire exit location, comprising a body that is configured to be inserted through an aperture on a sidewall of a female member in which the female member is coupled to the wire feeder at the wire exit location; the torch cable having a first end and a second end opposite thereto, the first end utilizes a first connection assembly to couple to the wire exit location of the wire feeder and the second end attaches to the torch, wherein the wire feeder delivers wire from the exit wire location through the torch cable to the torch for performance of a welding operation; the first connection assembly includes a male member integrated to the first end of the torch cable, wherein the male member mates with the female member to couple the torch cable to the wire exit location of the wire feeder; the male member includes a groove around a circumference of a sidewall of the first end of the male member; the body housing a pin that engages with the groove; and a handle that controls the pin and engagement with the groove, wherein the engagement of the pin within the groove attaches the male member to the female member and disengagement of the pin from the groove allows detachment of the male member from the female member.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates an exemplary, non-limiting embodiment of a welding system that uses a quick release mechanism to secure a torch or torch cable to a wire feeder;

FIG. 2 illustrates an exemplary, non-limiting embodiment of a wire feeder in a welding system;

FIG. 3 illustrates an exemplary, non-limiting embodiment of a wire feeder;

FIG. 4 illustrates an exploded view of a quick release mechanism, a female member, a male member, and a torch cable in accordance with the subject innovation;

FIG. 5 illustrates an exemplary, non-limiting embodiment of a quick release mechanism that is engaged to a groove to secure a portion of the wire feeder to a portion of the torch;

FIG. 6 illustrates an exemplary, non-limiting embodiment of a quick release mechanism that is disengaged to a groove to allow release of a torch from a portion of the wire feeder;

FIG. 7 illustrates a non-limiting embodiment of a cross-sectional view of a quick release mechanism in an engaged position that uses a biasing member;

FIG. 8 illustrates a non-limiting embodiment of a cross-sectional view of a quick release mechanism in a disengaged position that uses a biasing member;

FIG. 9 illustrates a non-limiting embodiment of a cross-sectional view of a quick release mechanism in an engaged position that uses a cam;

FIG. 10 illustrates a non-limiting embodiment of a quick release mechanism in a disengaged position that uses a cam; and

FIG. 11 illustrates a non-limiting embodiment of a cam used with a quick release mechanism.

### DETAILED DESCRIPTION OF THE INVENTION

Embodiments of the invention relate to welding methods or systems that include a quick release mechanism (also referred to as a “mechanism” or “quick connect”) used to secure a torch to a wire feeder. A mechanism can be attached to a wire feeder and employ a pin or member that mates with a groove in a torch connection to the wire feeder to prevent detachment. The mechanism can be used with a robot welding torch or automated welding system or a manual or semi-automatic welding torch or welding system. The quick release mechanism can be used with a wire feeder, a welding system, a wire delivery system, a connection system that couples a torch cable to a wire feeder, a connection system that couples a torch to a wire feeder, or a combination thereof

“Welding” or “weld” as used herein including any other formatives of these words will refer to depositing of molten material through the operation of an electric arc including but not limited to submerged arc, GTAW, GMAW, MAG, MIG, TIG welding, any high energy heat source (e.g., a laser, an electron beam, among others), or any electric arc used with a welding system. Moreover, the welding operation can be on a workpiece that includes a coating such as, but not limited to, a galvanized coating.

“Component” or “Controller” as used herein can be a portion of hardware, a portion of software, or a combination thereof that can include or utilize at least a processor and a portion of memory, wherein the memory includes an instruction to execute.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply without departing from the intended scope of coverage of the embodiments of the subject invention.

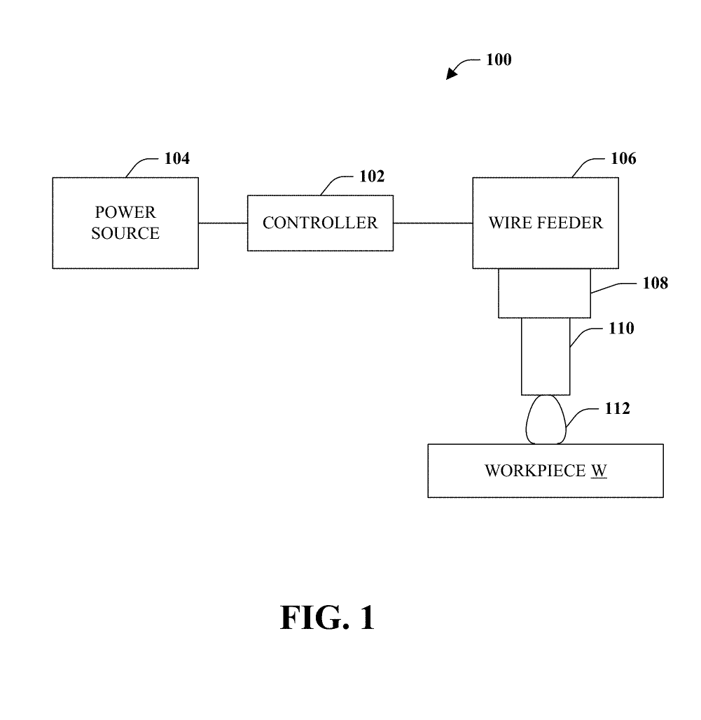

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, the FIG. 1 illustrates a welding system that is used with an automated, semi-automated, or manual welding system. Turning to FIG. 1, an exemplary, non-limiting embodiment of welding system 100 is illustrated. System 100 includes a welding torch 110 (also referred to as “torch”) having an electrode in which a power source 104 creates an arc 112 between an electrode and a workpiece W to complete an electrical circuit to perform a welding operation. System 100 can include the power source 104 that is configured to create the arc 112 between an electrode and workpiece W and further include a wire feeder 106 that is configured to deliver welding wire to a puddle formed by the electrode. A controller 102 can be configured to manage wire feed speed (WFS) of the wire feeder 106, the power source 104 that creates arc 112 for the welding operation, among others. It is to be appreciated that the system 100 can be used to perform a welding operation with a consumable electrode, a non-consumable electrode, a shielding gas, no shielding gas, or a combination thereof.

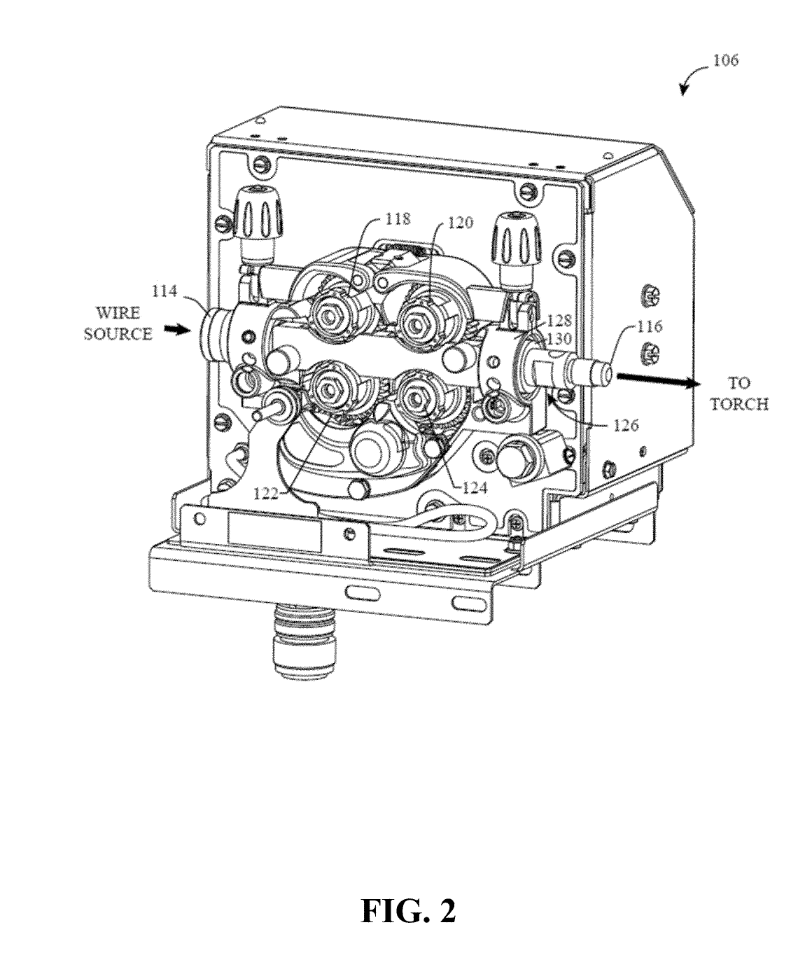

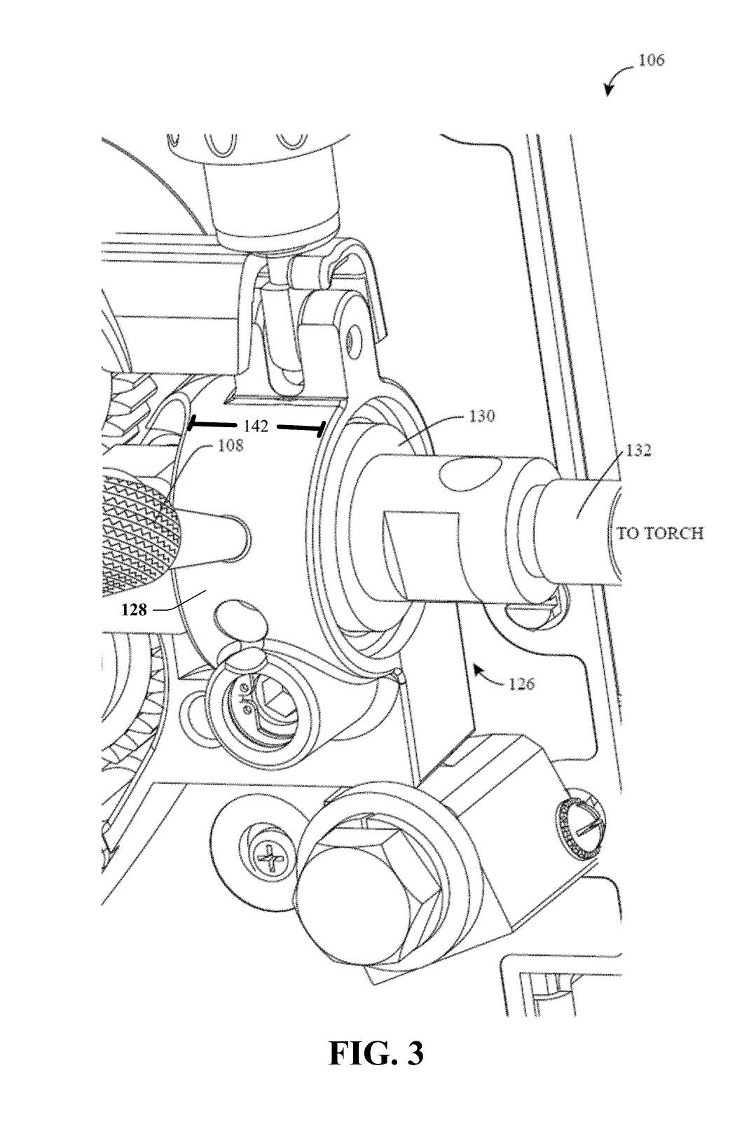

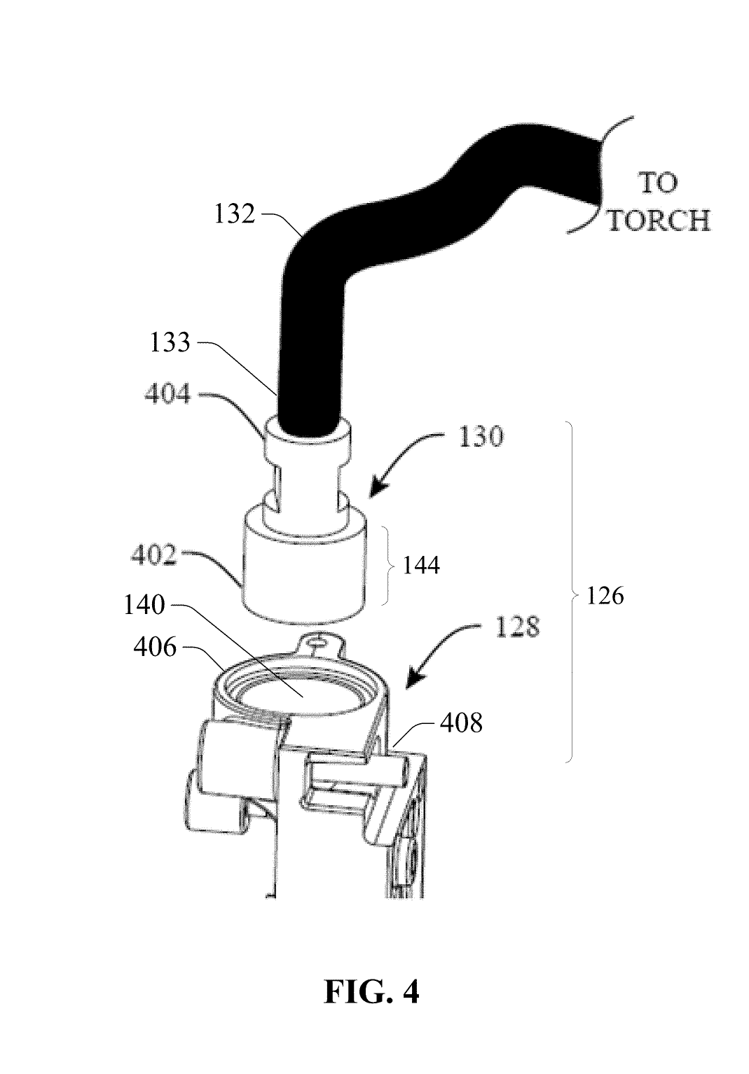

FIGS. 2-4 illustrate the wire feeder 106 that is configured to deliver wire to the torch 110 to perform a welding operation. FIG. 2 illustrates the wire feeder 106. FIG. 3 illustrates a coupling between the wire feeder 106 and the torch cable 132. FIG. 4 illustrates an exploded view of the coupling between the wire feeder 106 and the torch cable 132. The wire feeder 106 can include a wire entrance location 114 to which wire from a wire source is received. In an embodiment, the wire source can be a spool of wire for the particular welding operation. Moreover, the wire feeder 106 can include a support or arm to hold a spool of wire. The wire feeder 106 can include one or more drive rolls that drive the wire from the wire entrance location 114 to a wire exit location 116. The wire feeder 106 illustrated in FIG. 2 is depicted with four (4) drive rolls 118, 120, 122, and 124. The wire from the wire exit location 116 is further driven either directly to the torch 110 or indirectly to the torch 110 using a torch cable 132 (and at least one of a first connection assembly or a second connection assembly for coupling the torch cable to one of the wire feeder 106 or the torch 110). In the situation with an indirect feed to the torch 110, the wire can be delivered from the wire feeder 106 through a first connection on a first end of a torch cable 132, from the first connection on the first end of the torch cable 132 through the torch cable 132, from the torch cable 132 to a second connection on a second end of the torch cable 132 (opposite the first end), and from the second connection through to the torch 110.

Turning to FIGS. 3 and 4, the wire feeder 106 can include a first connection assembly 126 that couples the torch cable 132 to the wire feeder 106 which facilitates delivering wire via the torch cable 132 to the torch 110. The first connection assembly 126 can be on a first end 133 of the torch cable 132. Opposite the first end 133 of the torch cable 132 can be a second end. The second end of the torch cable 132 can be coupled to the torch 110 via a second connection assembly. In another embodiment, the second end of the torch cable 132 may not include the second connection assembly but rather the torch 110 is integrated to the second end of the torch cable 132.

As discussed, the torch cable 132 can connect the wire feeder 106 to the torch cable 132 to allow delivery of wire to the torch cable 132 for the welding operation. The torch cable 132 can include the first connection assembly 126 to releaseably couple the wire feeder 106 to an end of the torch cable 132. The first connection assembly 126 can include a female member 128 and a male member 130, wherein the female member 128 is secured to a portion of the wire feeder 106 or integrated to the wire feeder 106. In an embodiment, the female member 128 can mate with the male member 130, wherein the mating is based on a shape of the male member 130 fitting inside a shape of the female member 128. In other words, the female member 128 has a recess or hollow shape to which the male member 130 can fit inside or partially inside. For instance, the male member 130 can be a cylinder shape and the female member 128 can be a corresponding hole that receives the cylinder shape. In particular, the female member 128 can be a hollow cylinder shape to which the male member 130, having a solid cylinder shape, mates therein.

In an embodiment, the male member 130 can include a length, a first end and a second end opposite thereto, wherein the first end mates with the female member 128 such that a portion of the length resides inside the female member 128. Moreover, the first end of the male member 130 can include a first shape. The female member 128 can include a hollow area or recess to receive the male member 130 in which the hollow area or recess includes a depth, a first end and a second end opposite the first end, and a second shape for the first end. The first shape of the male member 130 can correspond to the second shape of the female member 128.

It is to be appreciated the male member 130 and the female member 128 can be include various dimensions (e.g., length, shape of first end, shape of second end, depth, among others) and such dimensions can be selected with sound engineering judgment without departing from the scope of the subject innovation. For instance, the female member 128 can be a first shape that allows receipt of a portion of a second shape of the male member 130. In still another embodiment in which the first shape and the second shape are circular or round-shaped, the first end of the male member 130 can further include a first diameter that is greater than a second diameter of the second end of the male member 130 (see FIG. 4). The second end of the male member 130 is further coupled or integrated to the torch cable 132.

A quick release mechanism 108 is configured to allow coupling of the wire feeder 106 to the torch cable 132. The quick release mechanism 108 can engage the first connection assembly 126 to facilitate securing the torch cable 132 to the wire feeder 106. In other words, the quick release mechanism 108 is configured to allow coupling or releasing between the male member 130 and the female member 128 which connect or disconnect the first end 133 of the torch cable 132 and the wire exit location 116. The quick release mechanism 108 or a portion thereof can be inserted into an aperture on a sidewall 142 of the female member 128 such that a portion of the quick release mechanism 108 engages a groove 204 on a sidewall 144 of the male member 130. In an embodiment, the quick release mechanism 108 can releaseably couple to the sidewall 142 via threading. In another embodiment, the quick release mechanism 108 can be inserted through the sidewall 142 without coupling to the sidewall or the female member 128. The quick release mechanism 108 blocks a path of disconnect or connect between the first end 402 and the female member 128.

The torch cable 132 can include a first end 133 and a second end opposite thereto, wherein the first end 133 of the torch cable 132 is connected to the wire feeder 106 at the wire exit location 116 and the second end of the torch cable 132 is connected to the torch 110. The torch 110 can be coupled via the second connection assembly to the second end of the torch cable 132 or integrated into the second end of the torch cable 132. The first end 133 of the torch cable 132 can be coupled to the wire feeder 106 via the first connection assembly 126 or integrated into the wire feeder 106. The connection assemblies, if used, between the torch cable 132 and the wire feeder 106 or the torch 110 can be releasable or non-releasable. It is to be appreciated that the torch cable 132 can be used to provide connectivity between the wire feeder 106 and the torch 110 in order for the torch 110 to receive wire for delivery from the exit wire location 116 to perform the welding operation. The connectivity between the wire feeder 106 and the torch 110 can include one or more connectors or connector assemblies in order to couple the torch cable 132. As discussed, a torch cable 132 can include a first connection assembly 126 on the first end 133 of the torch cable 132 to couple to the wire feeder 106. Additionally in such instance, the torch cable 132 can include a second connection assembly on a second end, opposite the first end 133, of the torch cable 132 to couple the second end to the torch 110 or another torch cable or another component to deliver wire to the torch 110. The connection assemblies, torch cables, extension cables, and other components that couple the wire feeder 106 to the torch 110 can be selected with sound engineering judgment without departing from the scope of the subject innovation. The torch cable 132 used to deliver the wire from the wire feeder 106 to the torch 110 can be secured to the wire feeder 106 by the quick release mechanism 108 so as to prevent detachment of the torch cable 132 and a short that can occur from the wire escaping the delivery path from the wire feeder 106 to the torch 110.

Turning to FIG. 4, an exploded view of the first connection assembly 126 is illustrated that includes the female member 128, the male member 130, and the torch cable 132 coupled or integrated to the male member 130. Torch 110 can include the male member 130 that mates with the female member 128, wherein the female member 128 is incorporated with or coupled to the wire feeder 106. The male member 130 can include a first end 402 and a second end 404 opposite thereof. The female member 128 can include a first end 406 and a second end 408 that is opposite the first end 406. The female member 128 can define a recess area 140 to which a portion of the male member 130 can fit inside. It is to be appreciated that the dimensions of the male member 130 and the female member 128 can be selected with sound engineering judgment such that the male member 130 mates with the female member 128.

In a particular example, the male member 128 is cylindrical in shape and the female member 130 defines a cylindrical recess (e.g., the recess area 140) that can receive a portion of the male member 130. In such, the first end 402 of the male member 130 can include a first diameter and the second end 404 of the male member 130 can include a second diameter, wherein the first diameter is greater than the second diameter. The first diameter of the first end 402 of the male member 130 can be configured to fit inside the female member 128 since the female member 128 has a cylindrical recess with a diameter that allows insertion of the male member 130. It is to be appreciated that the first end 133 of the torch cable 132 can be coupled or integrated to the male member 130 and a second end opposite of the first end 133 of the torch cable 132 can be integrated or coupled to the torch 110. It is to be appreciated that the male member 130 can be one piece as depicted or be one or more pieces. For example, the male member 130 can be a first piece being the second end 404 that is releaseably or permanently coupled to the first end 402.

The quick release mechanism 108 can be configured to secure the torch 110 or the torch cable 132 to the wire feeder 106. The torch 110 can be coupled to the wire feeder 106 via the first connection assembly in which there is no torch cable 132. In another example, the torch cable 132 can be coupled to the wire feeder 106 via the first connection assembly in which the torch cable 132 is coupled or integrated to the torch 110. In either embodiment, the torch 110 or torch cable 132 can include the first connection assembly 126 that includes the male member 130 that is secured and mated to the female member 128 of the wire feeder 106 such that the first connection assembly 126 releaseably couples the male member 130 to the female member 128. Conventionally, a screw system is used to prevent torch or torch cable from detaching from the wire feeder. The screw system includes a piece that gets wedged into contact with the male member 130 based on the amount of force the piece is screwed or turned. If the screw system becomes loose, as often does during delivery of wire for the welding operation, the torch or torch cable can detach from the wire feeder and wire from the wire feeder can be exposed causing a short or damage to the equipment, welding operation, among others. In order to prevent the torch 110 or the torch cable 132 from detaching from the wire feeder 106, the quick release mechanism 108 can removeably secure the torch 110 or torch cable 132 to the wire feeder 106 by passing through the sidewall 142 to engage a groove on the sidewall 144 of the male member 130. It is to be appreciated that the quick release mechanism 108 can be used in combination with a conventional screw system or be used to replace a screw system.

It is to be appreciated that the quick release mechanism 108 can be include a member or pin 202 that engages with the groove 204 and such member can be screwed to releaseably coupled to at least one of a portion of the wire feeder 106, the male member 130, or the female member 128. The member can be, but not limited to being, a hex screw, an Allen bolt or screw, a bolt, a screw, a metal pin, a pin, a metal, among others. In other words, the quick release mechanism 108 can be a member that configured to engage the groove 204 on the sidewall 144 of the male member 130 or a portion of the torch cable 132 or torch 110.

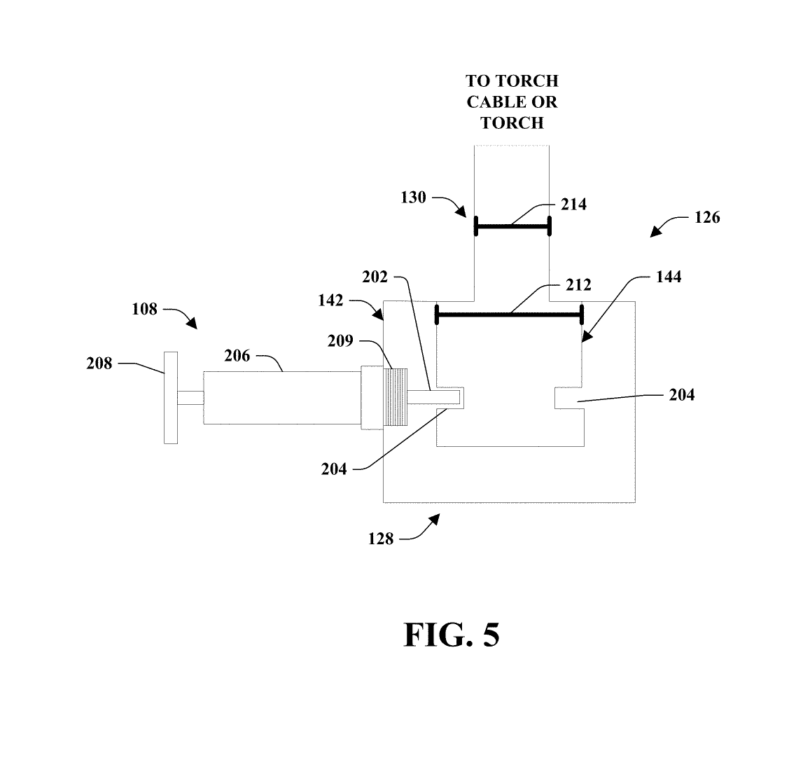

FIG. 5 illustrates the quick release mechanism 108 with the male member 130 mated with the female member 128 in a cross-sectional view. The quick release mechanism 108 can include a pin 202 (also referred to as a member) that is moveable to engage or disengage with a groove 204 on a portion of the sidewall of the male member 130. In particular, sidewall 144 can include the groove 204 on a portion or the entire circumference of the male member 130 such that an aperture on the sidewall 142 of the female member 128, which the quick release mechanism 108 passes through, aligns with the groove 204. The groove 204 can be located on a position in between the first end and the second end of the male member 130. In an embodiment, the groove 204 can be positioned on the sidewall 144 on the first end 402. The pin 202 can be movable to fit inside the groove 204 to prevent the torch 110 or the torch cable 132 from detaching from the wire feeder 106 and in particular preventing detaching of the male member 130 from the female member 128. Additionally, the pin 202 can be moveable to be outside the groove 204 to allow the torch 110 or the torch cable 132 to detach from the wire feeder 106 and in particular allowing detachment of the male member 130 from the female member 128. In an embodiment, a handle 208 can be used to engage or disengage the pin 202 with or from the groove 204. By way of example and not limitation, the handle 208 can be a push/pull or a twist/turn motion to control movement of the pin. The quick release mechanism 108 and features are discussed in more detail below.

It is to be appreciated that the quick release mechanism 108 and its components (e.g., a biasing member, a cam, a lip, a handle, a mounting surface, a pin, a body, apertures, and the like) can be fabricated from any suitable material used with a welding system, wire feeder, torch, or device used with performing a welding operation. In particular, the quick release mechanism 108 can be fabricated from a material such as, but not limited to, a metal, a steel, a polymer, an aluminum, a copper, a nickel, a brass, a composite material, or a combination thereof. In another embodiment, the quick release mechanism 108 can be a first material with a second material overlay in which the first material can be, but is not limited to, a metal, a steel, an aluminum, a copper, a nickel, or a composite material and the second material can be a rubber or polymer. The material composition of each component of the quick release mechanism 108 can be selected with sound engineering judgment without departing from the scope of the subject innovation.

The welding system 100 can include the wire feeder 106 directly coupled to the torch 110. In such an example, the quick release mechanism 108 can be inserted through or coupled to a portion of the wire feeder 106 in which a portion of the quick release mechanism 108 prevents the torch 110 from disconnecting a delivery path of wire from the wire feeder 106 to the torch 110 to perform the welding operation. In such an example, the wire delivery path is from the wire feeder 106 to the torch 110. In another example, the welding system 100 can include the wire feeder 106 coupled indirectly to the torch 110 via a torch cable 132 and one or more connection assemblies. In such an example, the wire delivery path is from the wire feeder 106 to the torch cable 132 to the torch 110. The quick release mechanism 108 can be used to secure the torch cable 132 to a portion of the wire feeder 106. In the situation where a connection assembly is used for one or more ends of the torch cable 132, the wire delivery path is from the wire feeder 106 to a connection assembly to the torch cable 132 to a connection assembly to the torch 110. The quick release mechanism 108 can be used to secure the connection assembly to a portion of the wire feeder 106. In general, the quick release mechanism 108 can be used by one or more connection assemblies in a delivery path of wire from the wire feeder 106 to the torch 110 in which such delivery path includes a male member and a female member that mate. For instance, a wire feeder 106 can include a torch cable having a first set of male member and female member on a first end to couple to the wire feeder and a second set of male member and female member on the second end to couple to the torch. In such instance, a first quick release mechanism can be used for the first set and a second quick release mechanism can be used for the second set to prevent detachment of the torch cable to the wire feeder and/or from the torch.

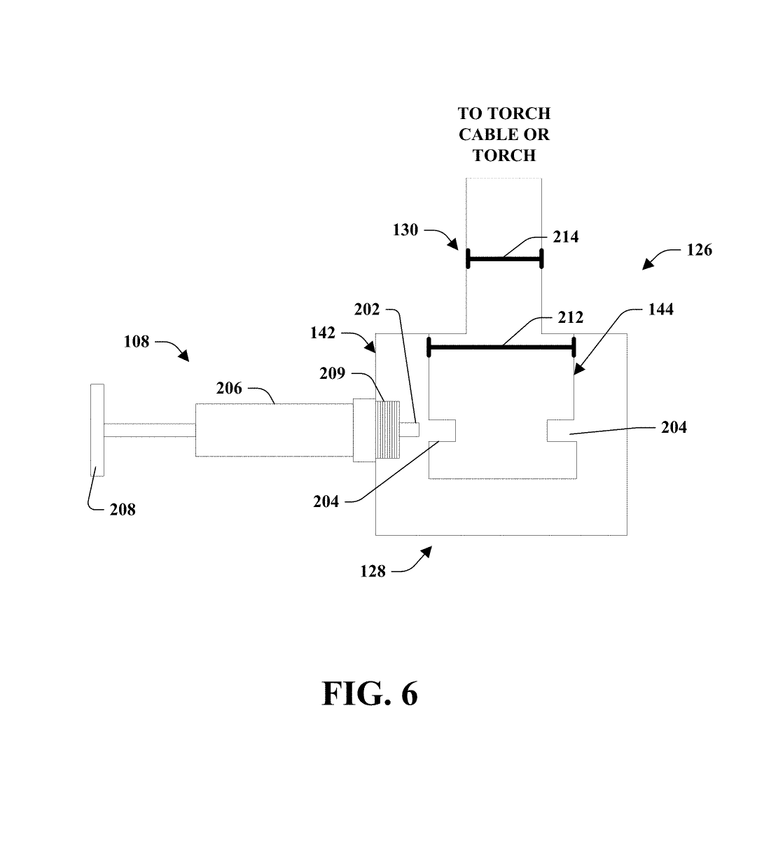

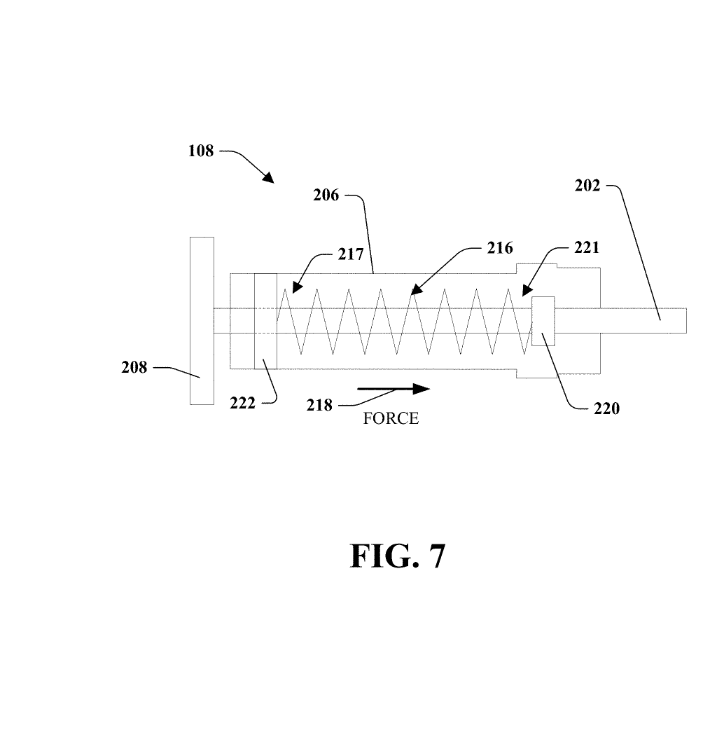

Continuing with FIGS. 5 and 6, the quick release mechanism 108 is illustrated with the pin 202 engaged with the groove 204 in FIG. 5 and disengaged in FIG. 6, wherein such engagement secures or disconnects the torch 110 to wire feeder 106. The quick release mechanism 108 can include the handle 208 that controls engagement of the pin 202 with the groove 204. The quick release mechanism 108 can include a body 206 that houses internal components described below in FIGS. 7-10. In an embodiment, the body 206 can house a portion of pin 202 (e.g., a portion of pin 202 is internal to body 206 and an additional portion of pin 202 is exposed outside body 206 to engage groove 204), connecting members between pin 202 and handle 208, among others. For instance, in a particular embodiment, body 206 can include a spring-loaded pin or a bias member loaded pin in which a spring or biasing member 216 is connected to a portion of handle 208 to allow controlling of whether to engage or disengage the pin 202 from the groove 204.

The body 206 can include a first end and a second end opposite thereto, wherein the first end includes an aperture for exposure of the handle 208 and the second end includes an aperture for the pin 202. In an embodiment, the quick release mechanism 108 can be removeably coupled to a portion of wire feeder 106 via a threading 209. The threading 209 can be on an exterior of the second end of the body 206 and mates with threading on an aperture of the sidewall 142. The quick release mechanism 108 can be coupled to a portion of wire feeder 106 such that the pin 202 can engage the groove 204 on sidewall 144 of the male member 130. In particular, the pin 202 of quick release mechanism 108 can be configured to engage the groove 204 on a first diameter 212 of the male member 130. A second diameter 214 of the male member 130 is further exposed from the wire feeder 106. It is to be appreciated that the first diameter 212 is greater than the second diameter 214 and that the first diameter 212 corresponds to first end 402 and the second diameter 214 corresponds to second end 404. Further, the pin 202 is able to engage and mate with the groove 204 to prevent the male member 130 of the first connection assembly 126 from detaching from the female member 128. It is to be appreciated that the pin 202 can be a first shape and the groove 204 can be a second shape such that first shape fits into or mates with the second shape to prevent movement of the male member 130 from the female member 128.

In another example, the handle 208 can be a key that is releasably connectable to body 206 or directly to the pin 202, wherein the pin 202 couples or decouples the male member 130 from the female member. For instance, the handle 208 can be detachable from the body 206 such that the quick release mechanism 108 is engaged with the pin 202 into the groove 204. For release, the handle can be affixed or inserted to the body 206, similar to a key, in order to allow release or decoupling of the pin 202 from the groove 204 thereby releasing the male member 130 from the female member 128.

The pin 202 can be a first shape that mates or engages with a portion of the sidewall 144 of the male member 130 or the groove 204 with a second shape that compliments the first shape. For example, the shapes can be, but are not limited to being, cylindrical, square, rectangle, polygon, curved, convex, concave, among others. In a non-limiting example, the pin 202 can be cylindrical in shape to engage into a groove 204 that allows mating with the cylindrical shaped pin. It is to be appreciated the first shape of the pin 202 can be selected with sound engineering judgment without departing from the scope of the subject innovation.

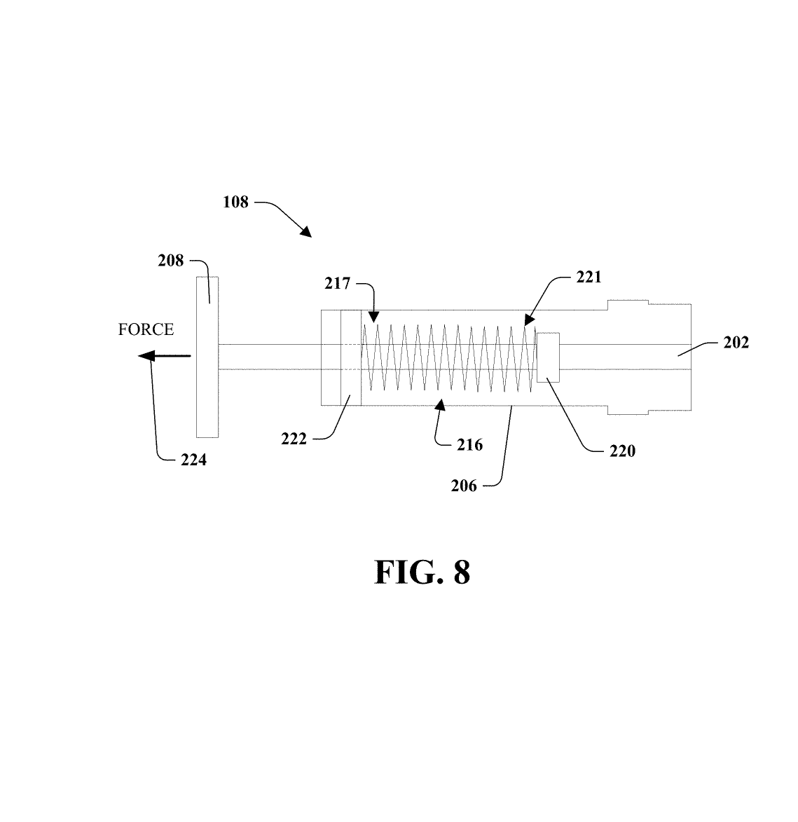

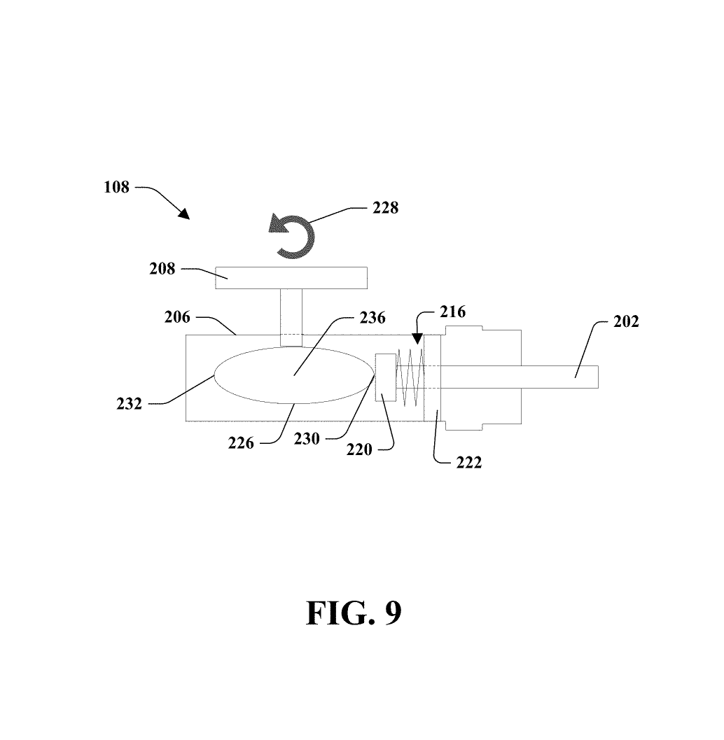

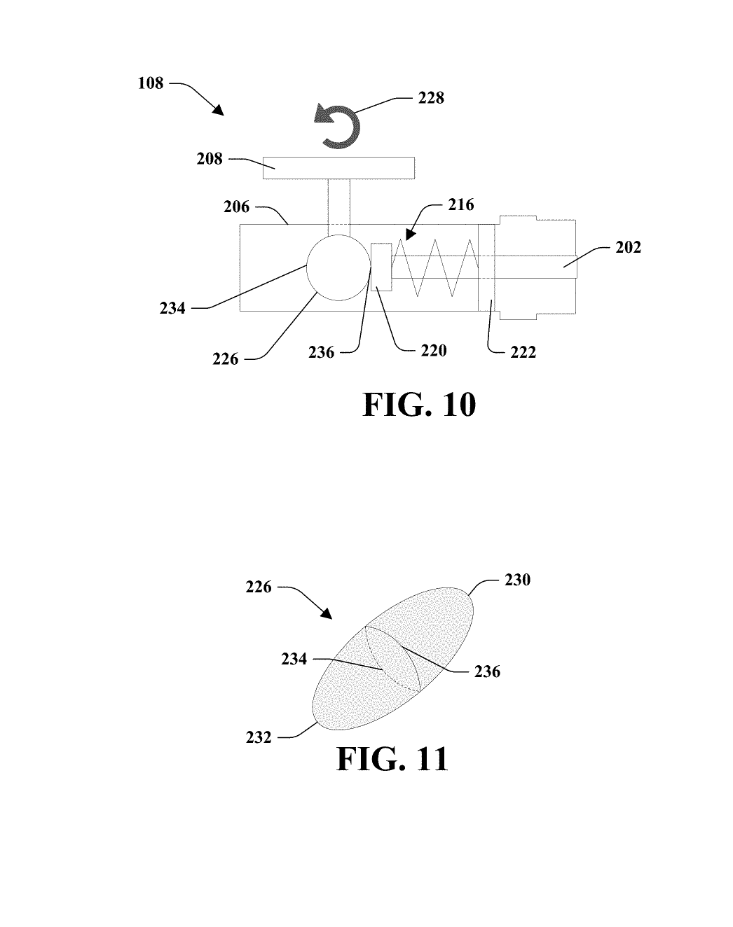

Turning to FIGS. 7-10, embodiments of the quick release mechanism 108 are illustrated. In particular, FIGS. 7-8 illustrate the quick release mechanism 108 that include a biasing member 216 and FIGS. 9-10 illustrate the quick release mechanism 108 that include a cam 226. It is to be appreciated that the embodiments discussed below are not to be limiting on the subject innovation and that internals of the quick release mechanism 108 can be selected with sound engineering judgment. For example, a spring and a cam can be employed. In another embodiment, the handle of the quick release mechanism 108 can be coupled to the pin via a gear train. By way of example and not limitation, the handle 208 can be coupled to the pin 202 in which a first end of the pin 202 is coupled to the handle 208 and a second end of the pin 202 is opposite the first end and engages the groove 204.

FIG. 7 illustrates the quick release mechanism 108 in an engaged position such that the pin 202 mates with a portion of the male member 130 and in particular with the groove 204. The quick release mechanism 108 includes the body 206 which can house the biasing member 216, wherein the biasing member 216 can include a first end 217 that can be connected to a surface 222 located at or near the first end of the body 206. The biasing member 216 provides a force 218 in a direction to move the pin 202 to engage with the groove 204. The force 218 can be initiated upon a compression of the biasing member 216, wherein the compression of the biasing member 216 can be from a pull of the handle 208. The pull from the handle 208 can cause a lip 220 to contact a second end 221 of the biasing member 216 and the first end 217 of the biasing member 216 presses against the surface 222 or an inside wall of the first end of the body 206. It is to be appreciated that the biasing member 216 can be, but is not limited to, a spring, a member that can translate a force upon compression or elongation. The biasing member 216 can be utilized to provide a force for the pin 202 to engage the groove 204 and a suitable component to provide force in such a direction can be utilized or selected by sound engineering judgment. By way of example and not limitation, the quick release mechanism 108 can utilize a biasing member that is a compressible material, a polymer, a rubber, multiple springs, a metal leaf structure, an elastic resistance material, a biasing member, among others.

The biasing member 216 can surround a portion of the pin 202 such that the pin 202 can slide through an aperture on the first end of the body 206 and the second end of the body 206, wherein the second end is opposite the first end and is positioned toward the groove 204. The biasing member 216 can be compressed by a force from the handle 208 such that the pin 202 is moved longitudinally. In an embodiment that does not utilize the surface 222 and the biasing member 216 is coupled to the second end of the pin 202, a pulling force on the handle 208 initiates the biasing member 216 to be compressed against an inside wall of the first end of the body 206. In another embodiment that does utilize the surface 222 and the biasing member 216 is coupled to the second end of the pin 202, a pulling force on the handle 208 initiates the biasing member 216 to be compressed against the surface 222. In an embodiment that does not utilize the surface 222 and the biasing member 216 is coupled to the lip 220 that is affixed to the second end of the pin 202, a pulling force on the handle 208 initiates the biasing member 216 to be compressed between an inside wall of the first end of the body 206 and the lip 220. In an embodiment that does utilize the surface 222 and the biasing member 216 is coupled to the lip 220 that is affixed to the second end of the pin 202, a pulling force on the handle 208 initiates the biasing member 216 to be compressed between the surface 222 and the lip 220. In an embodiment, the biasing member 216 can be unattached to at least one of the pin 202, the surface 222, the lip 220, or the body 2106. The configuration of the biasing member 216 can be selected with sound engineering judgment without departing from the scope of the subject innovation.

As seen in FIG. 7, the biasing member 216 can function to bias the pin 202 with a force 218 such that the pin 202 engages the groove 204 when inserted through the female member 128. In the engaged position, further movement of the pin 202 can be inhibited by at least one of the contact of the handle 208 with the first end of the body 206 (in a direction toward the female member 128), contact of the lip 220 with another surface inside the body (e.g. inside of the threading 209 portion, among others), contact of the end of the pin 202 with the inside of the groove 204, or a resting position of the biasing member 216 (e.g., no tension in the biasing member 216 toward the first end of the body 206 or the second end of the body 206). The quick release mechanism 108 is further illustrated in a disengaged position in FIG. 8. The handle 208 can be pulled in a direction away from the groove 204 with a force 224 (e.g., pulling) to compress the biasing member 216 based on the biasing member 216 being compressed between the lip 220 and the surface 222. The pulling force 224 on the handle 208 can cause the pin 202 to be removed from the groove 204 and retract at least partially into the body 206, wherein such disengaged position can allow disconnection between the male member 130 and the female member 128, and in turn the torch or torch cable from the wire feeder. As discussed above and in another embodiment, the handle 208 can be pulled in a direction away from the groove 204 with a force 224 (e.g., pulling) to compress the biasing member 216 between the lip 220 and an inside wall of the first end of the body 206.

FIG. 9 illustrates another embodiment of the quick release mechanism 108 in an engaged position such that the pin 202 mates with a portion of the male member 130 and in particular with the groove 204 on the sidewall 144. In an embodiment, the quick release mechanism 108 includes the body 206 which can house a cam 226 that provide movement of the pin 202 between an engaged position to a disengaged position. The cam 226 can be utilized with the biasing member 216 which provides a force to press the first end of the pin 202 against the cam 226, wherein a shape of the cam 226 can provide movement of the pin 202. In an embodiment, the biasing member 216 can include a first end 217 that can be connected to or in contact with the lip 220. The biasing member 216 can also include a second end that can be connected to or in contact with the surface 222 located within the body 206. In an embodiment, the surface 222 can be a separate surface within the body 206 (as depicted) or it can be a surface that is part of the body 206. The biasing member 216 can provide a force toward the first end of the pin 202 in a direction away from the groove 204 such that biasing member 216 force is from the surface 222 to the lip 220 to maintain contact with the cam 226. In particular, this force can be based on the compression of the biasing member 216 between the lip 220 and the surface 222 and in another embodiment between the lip 220 and a portion of a surface of the body 206.

The shape of the cam 226 can be selected with sound engineering judgment without departing from the scope of the subject innovation. In general, the cam 226 can be shape that has a path along a circumference in which the path translates to having a first position with a first distance end to end and a second position having a second distance from the side to side, wherein the second distance is shorter than the first distance.

For example, as depicted, the cam 226 can be an egg-shape having a length from a first end 230 to a second end 232 (shown in FIG. 9) and a width from a first side 234 to a second side 236 (shown in FIG. 10), wherein a path of circumference is defined in which alignment of the first end 230 to the second end 232 is a number of degrees from alignment of the first side 234 to second side 236. For example, with an egg-shape, the first end 230 to second end 232 alignment can be 90 degrees apart from the first side 234 to second side 236 alignment. The cam 226 can rotate around the path of circumference between a first position (shown in FIG. 9 for example) and a second position (shown in FIG. 10 for example) separated by a number of degrees, wherein the first position is defined as the first end 230 and the second end 232 are aligned in a plane of the pin 202 and the second position is defined as the first side 234 and the second side 236 are aligned in a plane of the pin 202. With the first end 230 and the second end 232 aligned, the first distance is greater than the second distance so as to move the pin 202 to the engaged position. With the first side 234 and the second side 236 aligned, the second distance is shorter than the first distance so as to allow the pin 202 to be in the disengaged position. In the engaged position illustrated in FIG. 9, the cam 226 is positioned to push the lip 220 in the direction of the groove 204. It is to be appreciated that a cam 226 having a cylindrical or egg-shape is illustrated in FIG. 11 and such depiction is solely for example and not to be limiting on the subject innovation.

In an embodiment, the handle 208 can extend perpendicularly outward from a sidewall of the body 206 and provide a rotational motion which can move the cam 226 about the path of circumference by a number of degrees proportional to the amount of turn of the handle 208. As the cam 226 rotates based on a rotational force 228 applied to the handle 208, the quick release mechanism 108 can transition between an engaged and a disengaged position. In another embodiment, the cam 226 and handle 208 can be configured such that the handle 208 can be turned any range of degrees, from 0 degrees to 360 degrees, to transition between engagement and disengagement of the pin 202 with the groove 204. In one example, the quick release mechanism 108 transitions between an engaged position (as seen in FIG. 9) and a disengaged position (as seen in FIG. 10) with approximately a 90 degree turn of the handle 208 in a first direction and back −90 degrees with a turn of the handle 208 in an opposite direction to the first direction. It is to be appreciated that the handle 208 and cam 226 can have a rotational relationship in which the handle turn or movement translated to the cam 226 providing the engaged position or the disengaged position and such rotational relationship can be selected with sound engineering judgement without departing from the scope of the subject innovation.

It is to be appreciated that the quick release mechanism 108 can be a size or a shape, having engagements, pins, or couplings based on a welding parameter for example. By way of example, the welding parameter can be a type of welding operation, a type of hose on the wire feeder 106, a type or shape of connector used with a torch or a torch cable, a wire exit location of a wire feeder, a type of wire feeder, a type of torch, a male connector, a female connector, a connector assembly, a type of shielding gas, a material composition of workpiece W, a welding pattern, a type of electrode, a composition of electrode, a wire feed speed, a waveform used for the welding operation, a polarity of a welding wire, a type of flux, a number of electrodes used in the welding operation, an arc voltage, a travel speed of a tractor welder that performs the welding operation, a travel speed of a torch that performs the welding operation, an arc current level, a height of torch, a distance between workpiece W and torch or an end of the electrode, an oscillation width of electrode, a temperature of welding wire, a temperature of electrode, a type of material of workpiece W, a frequency of oscillation of electrode, a polarity of the arc current, a polarity of the current for welding wire, a parameter that affects an arc current of the welding operation, a gauge of wire, a material of wire, an oscillation dwell, a left oscillation dwell, a right oscillation dwell, one or more temperatures of workpiece W at one or more locations on workpiece W, a temperature of workpiece W, any and all variation of advanced process controls (e.g., move controls, pulse-frequency, ramp rates, background level ratios, etc.), and the like.

In an embodiment, the engagement of the pin to the groove is based on a movement of the handle. In an embodiment, the movement is one of a push, a pull, or a turn. In an embodiment, the body includes a first end and a second end opposite thereto, the first end includes an aperture for the handle and the second end includes an aperture for the pin. In an embodiment, the pin is cylindrical in shape and the groove is rectangular in shape to receive the pin. In an embodiment, the handle is situated on a parallel plane compared to a plane in which the pin is moveable within. In an embodiment, the handle is situated on a perpendicular plane compared to a plane in which pin is moveable within. In an embodiment, a threading is provided on an exterior of the second end to couple with a threading on an inside of the aperture on the sidewall of the female member. In an embodiment, the quick release mechanism can include a biasing member that applies a force to engage the pin into the groove for an engaged position, wherein the biasing member can be compressed to disengage the pin from the groove at a disengaged position. In an embodiment, the pin includes a first end and a second end opposite thereto, wherein the pin protrudes from the aperture at the second end.

In an embodiment, the biasing member is affixed to a location on or proximate the second end of the pin. In an embodiment, the biasing member is compressed against an inside wall of the first end of the body with a pulling force on the handle. In an embodiment, the biasing member is compressed against a surface affixed to an inside of the body with a pulling force on the handle. In an embodiment, the biasing member is compressed between a lip affixed to the second end of the pin and at least one of an inside wall of the first end of the body or a surface.

In an embodiment, the quick release mechanism can include a cam that includes a first position and a second position, wherein the first position has a dimension that positions the pin into an engaged position and a second position has a dimension that positions the pin into a disengaged position and the handle being turned changes the cam between the first position and the second position.

In an embodiment, the handle is situated on a parallel plane compared to a plane in which the pin is moveable within. In an embodiment, the handle is situated on a perpendicular plane compared to a plane in which pin is moveable within. In an embodiment, the handle is moveable between a first position and a second position, wherein the first position corresponds to the pin at an engaged position with the groove and the second position corresponds to the pin at a disengaged position with the groove.

In an embodiment, the wire delivery system can include the handle is moveable to initiate engagement of the pin with the groove in which the movement of the handle compresses a biasing member or moves a cam.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

1. A connection system used with a welding system having a torch and a wire feeder, comprising:
a member that is configured to be inserted through an aperture on a sidewall of a female member in which the female member is coupled to a wire feeder;
a torch cable having a first end and a second end opposite thereto, the first end utilizes a first connection assembly to couple to a wire exit location of the wire feeder and the second end attaches to a torch, wherein the wire feeder delivers wire from the exit wire location through the torch cable to the torch for performance of a welding operation;
the first connection assembly includes a male member integrated to the first end of the torch cable, wherein the male member mates with the female member to couple the torch cable to the wire exit location of the wire feeder; and
the male member includes a groove around a portion of a circumference of a sidewall of the first end of the male member, wherein the groove is configured to receive the member to prevent detachment of the male member from the female member.

2. The connection system of claim 1, further comprising:
a quick release mechanism that includes a body and the body housing the member that engages with the groove; and
the quick release mechanism includes a handle that controls the pin and engagement with the groove, wherein the engagement of the pin within the groove attaches the male member to the female member and disengagement of the pin from the groove allows detachment of the male member from the female member.

3. The connection system of claim 2, the engagement of the pin to the groove is based on a movement of the handle and the movement is at least one of a push, a pull, or a turn.

4. The connection system of claim 2, the body includes a first end and a second end opposite thereto, the first end includes an aperture for the handle and the second end includes an aperture for the member.

5. The connection system of claim 4, the member is cylindrical in shape and the groove is rectangular in shape to receive the member.

6. The connection system of claim 4, the handle is situated on a parallel plane compared to a plane in which the member is moveable within.

7. The connection system of claim 4, the handle is situated on a perpendicular plane compared to a plane in which member is moveable within.

8. The connection system of claim 4, further comprising a threading on an exterior of the second end to couple with a threading on an inside of the aperture on the sidewall of the female member.

9. The connection system of claim 4, further comprising a biasing member that applies a force to engage the member into the groove for an engaged position, wherein the biasing member can be compressed to disengage the member from the groove at a disengaged position.

10. The connection system of claim 4, the member includes a first end and a second end opposite thereto, wherein the member protrudes from the aperture at the second end.

11. The connection system of claim 10, the biasing member is affixed to a location on or proximate the second end of the member.

12. The connection system of claim 10, the biasing member is compressed against an inside wall of the first end of the body with a pulling force on the handle.

13. The connection system of claim 10, the biasing member is compressed against a surface affixed to an inside of the body with a pulling force on the handle.

14. The connection system of claim 10, the biasing member is compressed between a lip affixed to the second end of the member and at least one of an inside wall of the first end of the body or a surface.

15. The connection system of claim 2, further comprising a cam that includes a first position and a second position, wherein the first position has a dimension that positions the member into an engaged position and a second position has a dimension that positions the member into a disengaged position and the handle being turned changes the cam between the first position and the second position.

16. A welding system, comprising:
a power supply configured to output a welding current to an electrode to create an arc between the electrode and a workpiece;
a wire feeder configured to deliver a welding wire to the arc;
at least one welding torch for performing a welding operation on the workpiece to create a weld joint, the welding torch includes the electrode;
a torch cable having a first end and a second end opposite thereto, the first end utilizes a first connection assembly to couple to a wire exit location of the wire feeder and the second end attaches to the at least one welding torch, wherein the wire feeder delivers wire from the exit wire location through the torch cable to the at least one welding torch for performance of the welding operation;
the first connection assembly includes a male member integrated to the first end of the torch cable, wherein the male member mates with the female member to couple the torch cable to the wire exit location of the wire feeder;
the male member includes a groove around a circumference of a sidewall of the first end of the male member;
a quick release mechanism attached to the wire feeder, the quick release mechanism comprises:
a body that is configured to be inserted through an aperture on a sidewall of a female member;
the body housing a pin that engages with the groove; and
a handle that controls the pin and engagement with the groove, wherein the engagement of the pin within the groove attaches the male member to the female member and disengagement of the pin from the groove allows detachment of the male member from the female member.

17. (canceled)

18. The welding system of claim 16, the handle is at least one of the following:
situated on a parallel plane compared to a plane in which the pin is moveable within; or
situated on a perpendicular plane compared to a plane in which pin is moveable within.

19. The welding system of claim 16, the handle is moveable between a first position and a second position, wherein the first position corresponds to the pin at an engaged position with the groove and the second position corresponds to the pin at a disengaged position with the groove.

20. A wire delivery system, comprising:
a wire source that provide a wire to a wire feeder at a wire entrance location;
one or more drive rolls that drive the wire from the wire entrance location to a wire exit location and through a torch cable to a torch;
a quick release mechanism that releaseably secures the torch cable to the wire exit location, comprising a body that is configured to be inserted through an aperture on a sidewall of a female member in which the female member is coupled to the wire feeder at the wire exit location;
the torch cable having a first end and a second end opposite thereto, the first end utilizes a first connection assembly to couple to the wire exit location of the wire feeder and the second end attaches to the torch, wherein the wire feeder delivers wire from the exit wire location through the torch cable to the torch for performance of a welding operation;
the first connection assembly includes a male member integrated to the first end of the torch cable, wherein the male member mates with the female member to couple the torch cable to the wire exit location of the wire feeder;
the male member includes a groove around a circumference of a sidewall of the first end of the male member;
the body housing a pin that engages with the groove; and
a handle that controls the pin and engagement with the groove, wherein the engagement of the pin within the groove attaches the male member to the female member and disengagement of the pin from the groove allows detachment of the male member from the female member.

21. The wire delivery system of claim 20, further comprising a movement of the handle to initiate engagement of the pin with the groove in which the movement of the handle compresses a biasing member or moves a cam.
